(19) United States
(12) Patent Application Publication
(10) Pub. No.: US 2011/0248979 A1
(43) Pub. Date: Oct. 13, 2011

(54) ELECTRO-OPTICAL DEVICE, CONTROL METHOD FOR ELECTRO-OPTICAL DEVICE, AND ELECTRONIC APPARATUS

(75) Inventor: Haruhiko NISHIMURA, Fujimi-machi (JP)

(73) Assignee: SEIKO EPSON CORPORATION, Tokyo (JP)

(21) Appl. No.: 13/081,358

(22) Filed: Apr. 6, 2011

(30) Foreign Application Priority Data
Apr. 8, 2010 (JP) 2010-089273

(51) Int. Cl. G09G 5/00

(52) U.S. Cl. 345/211

(57) ABSTRACT

Included are a driving circuit that divides one field into subfields and applies predetermined voltages to liquid crystal elements of pixels to turn on or off each of the pixels, and a determination unit that determines whether a first pixel to be turned off of the pixels is adjacent to a second pixel to be turned on of the pixels. The driving circuit applies a first voltage to the liquid crystal element corresponding to the first pixel and applies a second voltage higher than the first voltage to the liquid crystal element corresponding to the second pixel, and applies a third voltage higher than the first voltage and lower than the second voltage to the liquid crystal element of the first pixel for which the determination unit has determined that the first pixel is adjacent to the second pixel.

### BACKGROUND

1. Technical Field

The present invention relates to techniques for discouraging occurrence of so-called disclinations.

2. Related Art

In an electro-optical device of expressing intermediate gray scales by subfield driving, a frame is divided into a plurality of subfields, a pixel is turned on or off for each subfield, and each gray level is expressed by varying the turn-on or turn-off for each subfield and the time ratio among the subfields. In an electro-optical device including a liquid crystal panel, either level of a binary voltage is applied to a pixel electrode of each pixel. Therefore, when voltages at levels different from each other are applied to pixel electrodes adjacent to each other, an electric field to be directed from the pixel electrode to a counter electrode (or in the opposite direction) is sometimes directed toward the neighboring pixel electrode. Due to such a crosswise electric field, disclinations, which are defects in orientation of liquid crystal molecules, can occur to degrade the display quality of a liquid crystal panel. It is to be noted that JP-A-2008-46613 discloses that pixel data of each pixel is corrected so that the voltage ratio between a voltage applied to the pixel and a voltage applied to its neighboring pixel decreases, which results in reduction of disclinations.

In the case of expressing gray scales by subfield driving, a potential difference between pixel electrodes adjacent to each other is more likely to increase to pose a problem of the occurrence of disclinations than the case of a voltage modulation method that applies a voltage having an intensity in accordance with a gray level.

### SUMMARY

An advantage of some aspects of the invention is that the occurrence of disclinations is discouraged with a configuration in which a pixel is turned on or off by subfield driving.

A first aspect of the invention provides an electro-optical device including a plurality of pixels each of which has a liquid crystal element, a driving circuit that divides one field into a plurality of subfields, and applies predetermined voltages to the liquid crystal elements of the pixels to turn on or off each of the pixels, for each of the subfields according to a driving pattern in accordance with a gray level, and a determination unit that determines whether a first pixel to be turned off of the pixels is adjacent to a second pixel to be turned on of the pixels. On the one hand, the driving circuit applies a first voltage to the liquid crystal element corresponding to the first pixel and applies a second voltage higher than the first voltage to the liquid crystal element corresponding to the second pixel. On the other hand, the driving circuit applies a third voltage higher than the first voltage and lower than the second voltage to the liquid crystal element of the first pixel for which the determination unit has determined that the first pixel is adjacent to the second pixel. According to the first aspect of the invention, with a configuration in which a pixel is turned on or off by subfield driving, the occurrence of disclinations can be discouraged. The aspect of the invention may be applied without devising a new structure of the pixel. Furthermore, in cases where the first pixel to be turned off and the second pixel to be turned on are adjacent to each other, the voltage applied to the first pixel is set to the third voltage, which enables the limitation imposed on the brightness of displayed contents to be reduced.

In the first aspect of the invention, it is preferable that the determination unit store a first threshold and a second threshold greater than the first threshold, as thresholds set so as to be associated with each gray level, and determine whether a difference between gray levels specified for the first pixel and the second pixel adjacent to each other is equal to or greater than the first threshold that is associated with a gray level specified for the first pixel, and equal to or less than the second threshold that is associated with the gray level specified for the first pixel, and that the driving circuit apply the third voltage to the liquid crystal element of the first pixel for which the determination unit has determined that the first pixel is adjacent to the second pixel and that the difference is equal to or greater than the first threshold and equal to or less than the second threshold. According to the first aspect of the invention, based on the gray level specified for the first pixel and the difference between gray levels of the first pixel and the second pixel, the voltage applied to the first pixel can be set to the third voltage in cases where the quality of displayed contents can be degraded. This enables the occurrence of disclinations to be discouraged, and enables the limitations imposed on the brightness of displayed contents to be further reduced.

A second aspect of the invention provides an electro-optical device including a plurality of pixels each of which has a liquid crystal element, a driving circuit that divides one field into subfields including a plurality of first subfields in accordance with a gray level of the each of the pixels and a second subfield different from the first subfields, and turns on or off each of the pixels for each of the subfields, and a determination unit that determines whether a first pixel to be turned off of the pixels is adjacent to a second pixel to be turned on of the pixels. The driving circuit turns on or off the each of the pixels according to a driving pattern in accordance with the gray level for each of the first subfields, and turns on the first pixel for which the determination unit has determined that the first pixel is adjacent to the second pixel, for the second subfield. According to the second aspect of the invention, with a configuration in which a pixel is turned on or off by subfield driving, the occurrence of disclinations can be discouraged. The aspect of the invention may be applied without devising a new structure of the pixel. Furthermore, in cases where the first pixel to be turned off and the second pixel to be turned on are adjacent to each other, the voltage applied to the first pixel is set to the third voltage, which enables the limitation imposed on the brightness of displayed contents to be reduced.

In the second aspect of the invention, it is preferable that the second subfield be a period shorter than any of the plurality of first subfields. According to the second aspect of the invention, the influence of the second subfield upon gray scale expression of pixels can be reduced.

In the second aspect of the invention, it is preferable that the driving circuit apply one level of a binary voltage when turning on each of the pixels, and apply the other level of the binary voltage when turning off each of the pixels, for the first and second subfields. According to the second aspect of the invention, the voltage applied to a liquid crystal element is one level of a binary voltage. Therefore, the second aspect of the invention may be applied using a driving circuit that has already been manufactured without devising a new structure of the pixel.

In the second aspect of the invention, it is preferable that the determination unit store a first threshold and a second threshold greater than the first threshold, as thresholds set so as to be associated with each gray level, and determine whether a difference between gray levels specified for the first pixel and the second pixel adjacent to each other is equal to or greater than the first threshold associated with a gray level specified for the first pixel and equal to or less than the second threshold associated with the gray level specified for the first pixel, and that the driving circuit turn on the first pixel for the second subfield for the liquid crystal element of the first pixel for which the determination unit has determined that the first pixel is adjacent to the second pixel and that the difference is equal to or greater than the first threshold and equal to or less than the second threshold. According to the second aspect of the invention, based on the gray level specified for the first pixel and the difference between gray levels of the first pixel and the second pixel, the voltage applied to the first pixel can be set to the third voltage in cases where the quality of displayed contents can be degraded. This enables the occurrence of disclinations to be discouraged, and enables the limitations imposed on the brightness of displayed contents to be further reduced.

In the second aspect of the invention, the driving circuit may divide one field such that the second subfield temporally follows the plurality of first subfields. According to the second aspect of the invention, the configuration of a plurality of first subfields in one field can be prevented from being changed.

In the second aspect of the invention, for the subfields for turning on or off according to the driving pattern in accordance with the gray level, the driving circuit may cause the subfield for turning on to temporally precede the subfield for turning off. According to the second aspect of the invention, even with a configuration of subfields that allows disclinations to be likely to occur, the occurrence of disclinations can be discouraged.

In addition, the invention may be conceptualized as, in addition to an electro-optical device, a control method for an electro-optical device, and an electronic apparatus including the electro-optical device.

### BRIEF DESCRIPTION OF THE DRAWINGS

The invention will be described with reference to the accompanying drawings, wherein like numbers reference like elements.

FIG. 1 illustrates an overall configuration of an electro-optical device.

FIG. 2 illustrates a configuration of a liquid crystal panel.

FIG. 3 illustrates an equivalent circuit of the liquid crystal panel.

FIG. 4 illustrates a configuration of a field.

FIG. 5 illustrates contents of conversion performed by an SF conversion unit.

FIG. 6 is a block diagram illustrating a configuration of a determination unit.

FIG. 7 illustrates an image represented by display data.

FIGS. 8A and 8B illustrate pixels as seen along the arrangement direction thereof.

FIGS. 9A and 9B are timing charts illustrating time series variations of data signals.

FIG. 10 illustrates a configuration of a field.

FIG. 11 illustrates a configuration of a determination unit.

FIG. 12 is a timing chart illustrating time series variations of data signals.

FIG. 13 is a plan view illustrating a configuration of a projector.

### DESCRIPTION OF EXEMPLARY EMBODIMENTS

Embodiments of the invention will be described below with reference to the accompanying drawings.

### First Embodiment

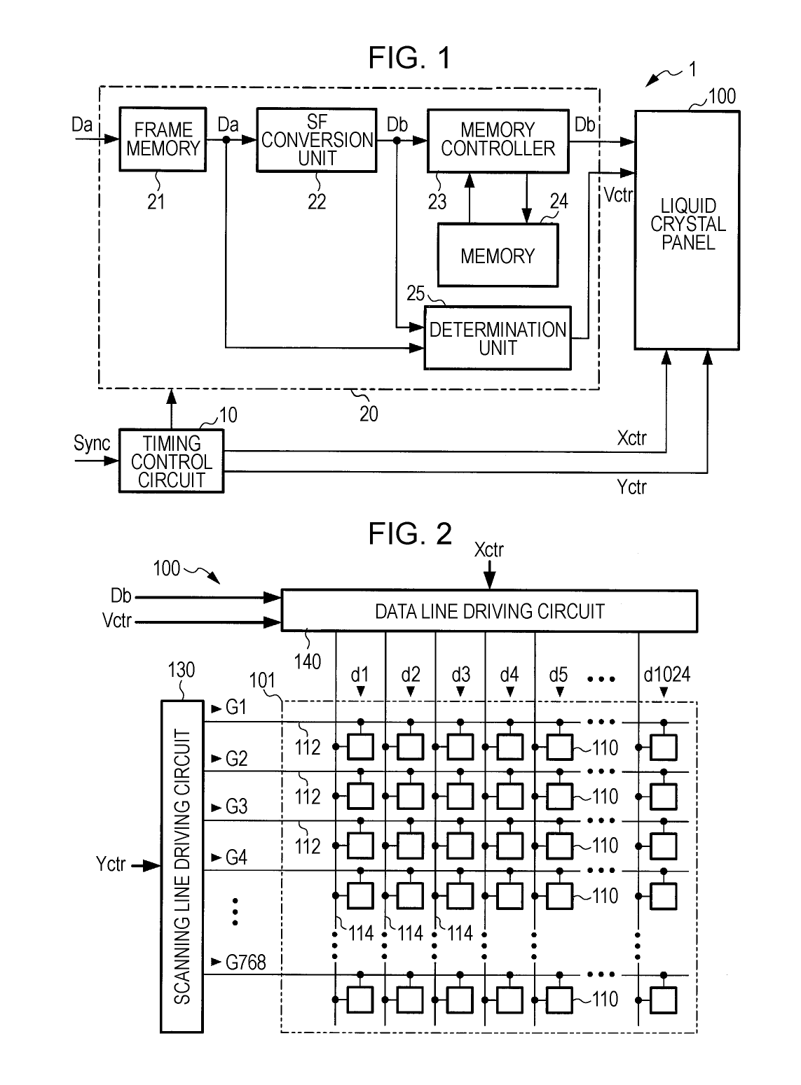

FIG. 1 is a block diagram illustrating an overall configuration of an electro-optical device according to a first embodiment. As illustrated in FIG. 1, in the configuration of an electro-optical device 1, components are broadly divided into a timing control circuit 10, a liquid crystal panel 100 and a display control circuit 20.

The timing control circuit 10 generates various control signals and controls units in synchronization with synchronization signals Sync provided from a higher-level device (not illustrated). The display control circuit 20 is supplied with display data Da from an external device in synchronization with the synchronization signal Sync. The display data Da is digital data specifying the gray level of each pixel in the liquid crystal panel 100. The display data Da is supplied in the order of scans based on a vertical scanning signal, a horizontal scanning signal and a dot clock signal (all not illustrated) included in the synchronization signal Sync. The display control circuit 20 processes the display data Da, and outputs to the liquid crystal panel 100 a data bit Db specifying the gray level of each pixel and a voltage control signal Vctr for controlling a voltage to be applied to a pixel electrode. The liquid crystal panel 100 is, for example, an active-matrix type display device in which each pixel is driven by a switching element such as a transistor. It is to be noted that although the display data Da specifies the gray level of each pixel (a pixel 110 to be described later) of the liquid crystal panel 100, a voltage to be applied to a liquid crystal element is set in accordance with the gray level, and therefore it can be safely said that the display data Da specifies the voltage to be applied to the liquid crystal element.

FIG. 2 illustrates a configuration of the liquid crystal panel 100. As illustrated in FIG. 2, in a display region 101 where an image is displayed, in the liquid crystal panel 100, 1st, 2nd, 3rd, . . . , 768th scanning lines 112 are provided to extend in one direction (lateral direction in the drawing). Further, in the display region 101, 1st, 2nd, 3rd, . . . , 1024th data lines 114 are provided to extend in a direction (longitudinal direction in the drawing) perpendicular to the scanning lines 112. The data lines 114 and the scanning lines 112 are provided to be kept electrically isolated from each other. The pixels 110 are provided at positions of the respective intersections of the 768 scanning lines 112 and the 1024 data lines 114. Accordingly, in this embodiment, in the display region 101, the pixels 110 are arranged in a matrix 768 rows long by 1024 columns wide.

A scanning line driving circuit 130 and a data line driving circuit 140 are disposed on the periphery of the display region 101. The scanning line driving circuit 130 selects the scanning line 112 specified by a selection signal Yctr that is supplied over a frame from the timing control circuit 10. The scanning line driving circuit 130 sets scanning signals for the selected scanning lines 112 to level H that corresponds to a selection voltage, and, on the other hand, sets scanning signals for the other scanning lines 112 to level L that corresponds to a non-selection voltage. In FIG. 2, scanning signals supplied to the 1st, 2nd, 3rd, . . . , 768th scanning lines 112 are designated by G1, G2, G3, . . . , G768, respectively.

The data line driving circuit 140 supplies data signals at voltage levels in accordance with the data bit Db and the voltage control signal Vctr to the 1st to 1024th data lines 114, respectively, based on a selection signal Xctr supplied from the timing control circuit 10. The data line driving circuit 140 drives the pixels 110 using a subfield driving method. The data line driving circuit 140 turns on or off the pixels 110 according to the driving pattern in accordance with a gray level, for each subfield. In FIG. 2, data signals supplied to 1st, 2nd, 3rd, . . . , 1024th data lines 114 are designated by d1, d2, d3, . . . , d1024, respectively. It is to be noted that the term “frame” as used herein means a period required to display one film frame's worth of an image by driving the liquid crystal panel 100. That period is as follows. For example, if a vertical scanning signal included in the synchronization signal Sync has a frequency of 60 Hz, the period is about 16.7 ms, which is the reciprocal of the frequency.

The pixel 110 has a well-known liquid crystal element in which a liquid crystal is sandwiched between a pixel electrode and a common electrode. Upon selection of the scanning line 112, a data signal that has been supplied to the data line 114 is applied to the pixel electrode.

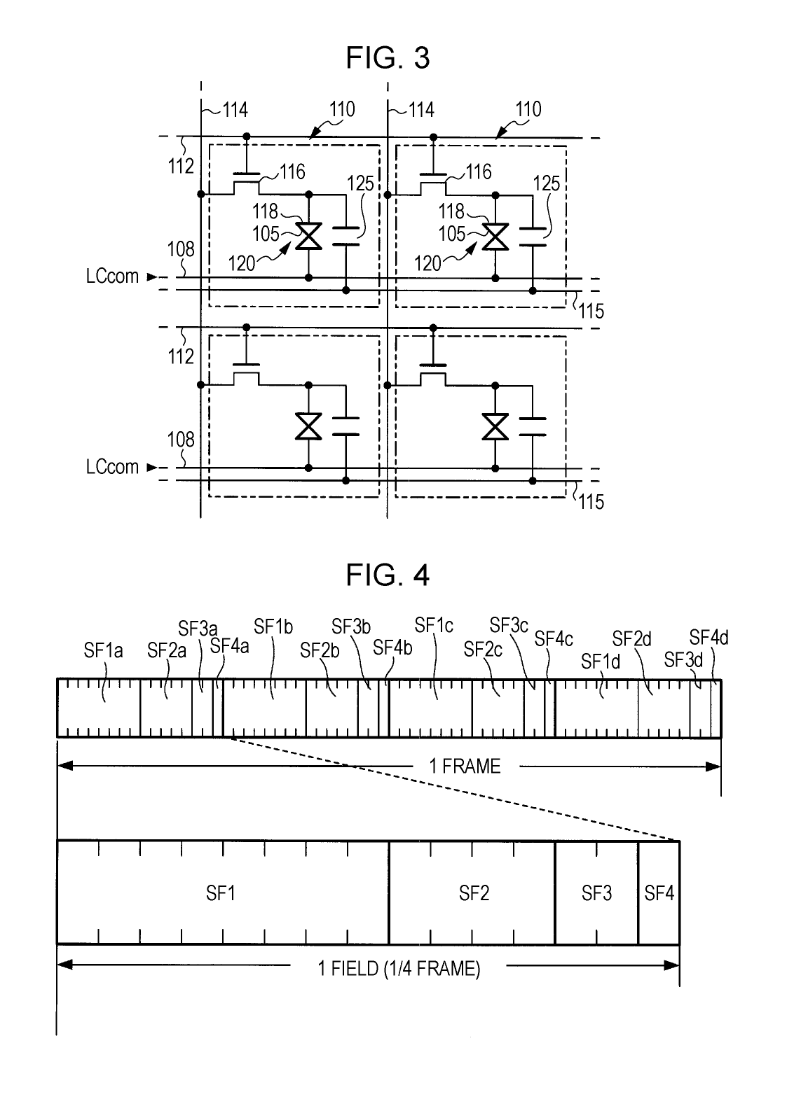

FIG. 3 illustrates an equivalent circuit of the liquid crystal panel 100. As illustrated in FIG. 3, the liquid crystal panel 100 has the following configuration. Liquid crystal elements 120 in which a liquid crystal 105 is sandwiched between the pixel electrode 118 and the common electrode 108 are arranged at positions of intersections of the scanning lines 112 and the data lines 114. In the equivalent circuit of the liquid crystal panel 100, auxiliary capacitors (storage capacitors) 125 are provided in parallel to the liquid crystal elements 120. The auxiliary capacitor 125 has one end connected to the pixel electrode 118 and the other end commonly connected to a capacitor line 115. The capacitor line 115 is maintained at a temporally constant voltage. Here, when the signal of the scanning line 112 becomes level H, a thin film transistor (TFT) 116 whose gate electrode connected to the scanning line is turned on for the pixel electrode 118 to be connected to the data line 114. Therefore, with the scanning line 112 at level H, if a data signal at the voltage level in accordance with a gray scale is supplied to the data line 114, the data signal is then supplied through the turned-on TFT 116 to the pixel electrode 118. When the signal of the scanning line 112 becomes level L, the TFT 116 is turned off whereas the voltage applied to the pixel electrode is maintained by the capacitive nature of the liquid crystal element 120 and the auxiliary capacitor 125. In the liquid crystal element 120, the molecular orientation state of the liquid crystal 105 changes in accordance with an electric field generated by the pixel electrode 118 and the common electrode 108. Therefore, the liquid crystal element 120, if of a transmission type, has a transmittance in accordance with the applied and maintained voltage. In the liquid crystal panel 100, the transmittance varies from one liquid crystal element 120 to another, and therefore the liquid crystal element 120 is equivalent to the pixel 110. The arrangement area for the pixels serves as the display region 101.

In this embodiment, the liquid crystal 105 is of a vertical alignment (VA) method, and a normally black mode is employed in which the liquid crystal element 120 is in a black state in the absence of an applied voltage. The data signal can be at an OFF level (here assumed as 0 V) as a voltage level (a first voltage) corresponding to the data bit Db “0”, and at an ON level (here assumed as 5 V) as a voltage level (a second voltage) corresponding to “1”. In addition, the data signal can be at a “correction level” (a third voltage) higher in potential than the OFF level and lower in potential than the ON level, as another voltage level corresponding to the data bit Db “0”. Here, the correction level is assumed as 1 V. The liquid crystal element 120 is in the normally black mode, and therefore becomes a dark state when a signal at the OFF level is applied to the pixel electrode 118 to turn off the pixel 110. On the other hand, the liquid crystal element 120 becomes a bright state when a signal at the ON level is applied to turn on the pixel 110. In addition, when a signal at the correction level is applied to turn off the pixel 110, the liquid crystal element 120 has a higher brightness than that when a signal at the OFF level is applied. However, it can be said that such a difference in brightness is hardly noticeable to a user. The reason why the third voltage is termed the “correction level” in this embodiment is that if predetermined conditions are satisfied when the data line driving circuit 140 supplies a data signal at the OFF level based on the data bit Db, the data line driving circuit 140 corrects the data signal to another voltage to turn off the pixel 110. That is, the turn-off driving is performed by the supply of a data signal at the OFF level or at the correction level.

To prevent the degradation of the liquid crystal 105, a pixel capacitor should be driven in principle with an alternating current. In cases where the liquid crystal element 120 is driven with an alternating current, for the ON level and the correction level, two kinds of polarities are required: a positive polarity higher in potential than the center amplitude voltage, and a negative polarity lower in potential than the center amplitude voltage. On the other hand, for the OFF level, if no voltage is applied to the liquid crystal element 120, there is one kind of voltage, a voltage LCcom applied to the common electrode 108, which is irrelevant to the polarity, whereas if the applied voltage is in the vicinity of zero, two kinds of polarities are required: the positive polarity and the negative polarity with respect to the center amplitude voltage. It is to be noted that, for voltages as used in embodiments, except for a voltage applied to the liquid crystal element 120, a ground potential (not illustrated) is regarded as a reference of zero voltage unless otherwise specified. The voltage applied to the liquid crystal element 120 is a potential difference between a voltage LCcom of the common electrode 108 and the pixel electrode 118, and is distinguished from other voltages.

Next, the configuration of the display control circuit 20 is described with reference to FIG. 1. The display control circuit 20 includes a frame memory 21, an SF conversion unit 22, a memory controller 23, a memory 24 and a determination unit 25. The frame memory 21 has storage regions corresponding to a pixel array 768 rows long by 1024 columns wide. Each storage region stores the display data Da specifying the gray level of the pixel 110 corresponding to that storage region. It is to be noted that the display data Da is supplied from a higher-level device and is written to the storage regions of the frame memory 21. Under control of the timing control circuit 10, the display data Da corresponding to one row of pixels that are positioned on the scanning line selected on the basis of the selection signal Xctr are read from the frame memory 21.

The SF conversion unit 22 converts the display data Da, which has been read from the frame memory 21, to the data bit Db in order to specify that the pixel 110 be turned on (hereinafter sometimes referred to “turn-on driving”) or turned off (hereinafter sometimes referred to “turn-off driving”) in accordance with the gray level specified for the pixel 110, for each subfield. The SF conversion unit 22 stores, for example, a look up table (LUT) representing a corresponding relation between a gray level and the data bit Db, and performs conversion based on the corresponding relation. It is to be noted that the term “data bit Db” as used herein means a data bit specifying a 256-level gray scale of from “0”, the darkest gray level, to “255”, the brightest gray level, for the gray level to be expressed by using pixels.

FIG. 4 illustrates a configuration of a field. As illustrated in FIG. 4, in this embodiment, one frame is equally divided into four, and each period obtained by this division corresponds to one field. One field is further divided into four subfields. Subfields are identified by reference characters illustrated in FIG. 4. Subfields whose reference characters have the same last alphabetic digit are included in the same one field. Subfields whose reference characters have the same numerical digit immediately preceding the last digit have the same period length. Hereinbelow, if subfields having the same period length in each field need not be distinguished from one another, the subfields will be designated by reference characters with an omission of their last alphabetic digits. In this embodiment, one field is divided into four subfields SF1 to SF4 that are different in period length from one another. The periods of the subfields SF1 to SF4 decrease in the order SF1>SF2>SF3>SF4.

The SF conversion unit 22 determines, for each of the subfields, which of turn-on driving and turn-off driving is performed, so that all gray scales can be expressed. The SF conversion unit 22 determines the turn-on driving or turn-off driving for each subfield in accordance with the gray level, and outputs the data bit Db representing the determined content. Further, the SF conversion unit 22 is configured to output the data bits Db so that a subfield for turn-on driving temporally precedes a subfield for turn-off driving. In other words, the display control circuit 20 and the data line driving circuit 140 are configured such that, in the case of inclusion of a subfield of turn-off driving in one field, the subfield of turn-off driving is always placed after a subfield for which the data line driving circuit 140 turns a pixel off.

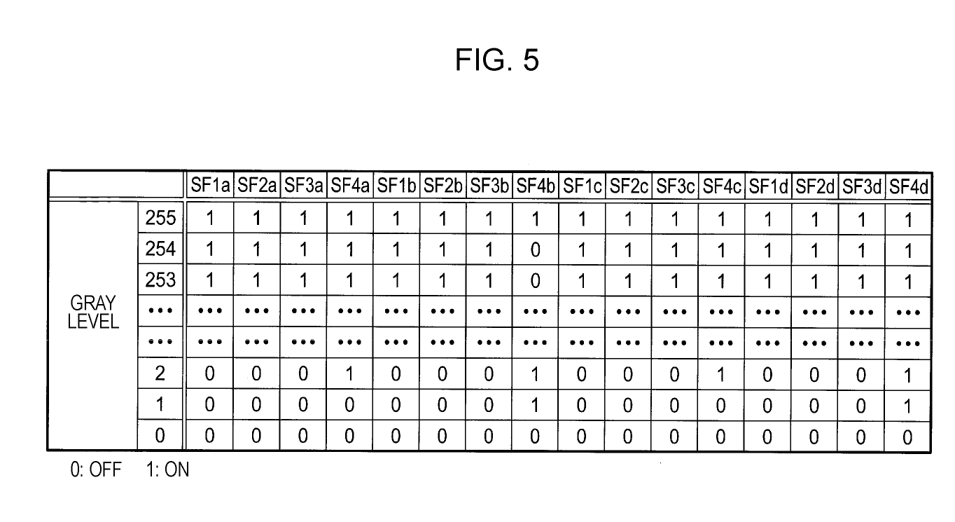

FIG. 5 illustrates contents of conversion performed by the SF conversion unit 22. In the case where the gray level has the minimum value “0”, “0” meaning turn-off driving is defined for all the subfields. In the case where the gray level has the maximum value “255”, “1” meaning turn-on driving is defined for all the subfields. Further, it is defined that, in the case where the gray level has a value “1”, turn-on driving indicated by “1” is performed only for subfields SF4b and SF4d, and that, in the case where the gray level has a value “254”, turn-off driving is performed only for the subfield SF4b. It is to be noted that the longer a subfield is, the more the subfield can contribute to the brightness of display during turn-on driving. The larger the number of subfields for turn-on driving in one field is, the more the subfields can contribute to the brightness. In addition, turn-on driving or turn-off driving for subfields of each pixel 110 is performed at the time of selection of the scanning line 112, and therefore, strictly speaking, the timing of a frame varies for every scanning line 112 in terms of time.

With reference back to FIG. 1, a description is given. The memory controller 23 writes the data bit Db supplied from the SF conversion unit 22 into the memory 24. The memory controller 23 reads the data bit Db stored in the memory 24 and outputs the read data bit Db in accordance with the driving timing of the liquid crystal panel 100. The determination unit 25 acquires both the display data Da read from the frame memory 21 and the data bit Db supplied from the SF conversion unit 22. Then, the determination unit 25 outputs the voltage control signal Vctr, which specifies for each pixel 110 in accordance with the acquired display data Da and the data bit Db, to the liquid crystal panel 100.

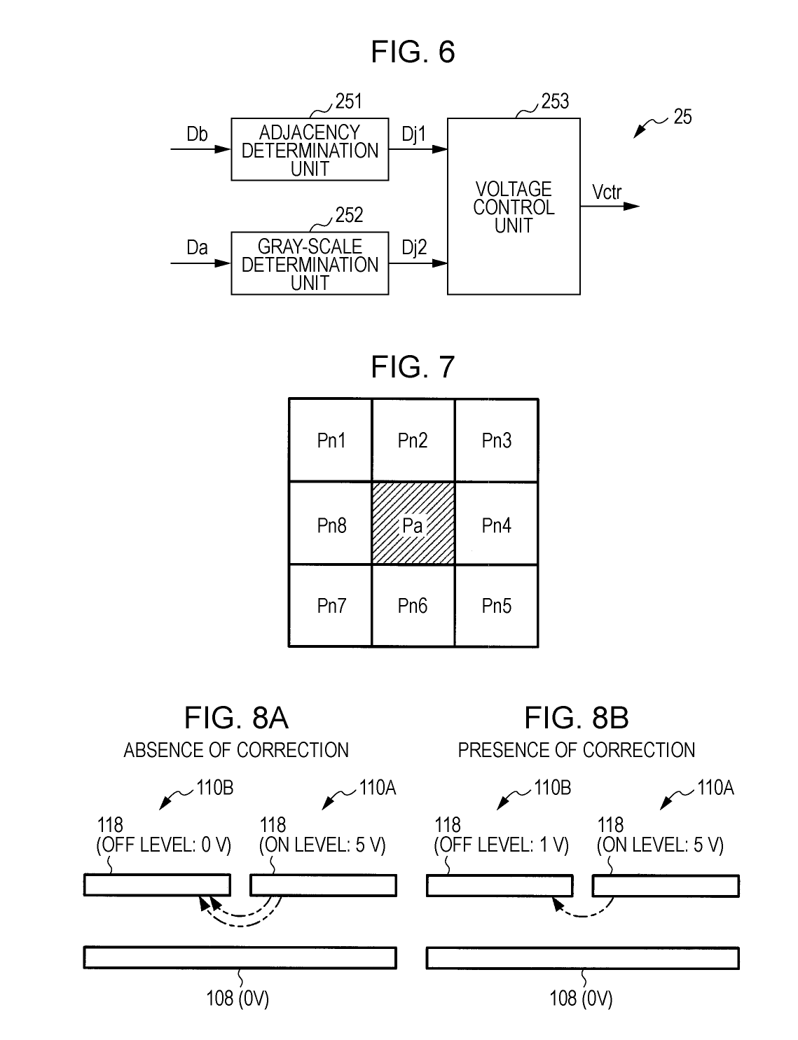

FIG. 6 is a block diagram illustrating a configuration of the determination unit 25. FIG. 7 schematically illustrates part of an image represented by the display data Da. Each rectangle illustrated in FIG. 7 corresponds to one pixel. An attention pixel is designated as Pa, and a total of eight pixels adjacent to the attention pixel are designated as Pn1 to Pn8 as illustrated.

As illustrated in FIG. 6, the determination unit 25 includes an adjacency determination unit 251, a gray-scale determination unit 252 and a voltage control unit 253. The functions implemented by the determination unit 25 may be implemented using hardware, and the functions that can be implemented using software may be implemented by execution of software. The adjacency determination unit 251 determines on the basis of the data bits Db whether the pixel 110, when to be turned off, is adjacent to the pixel 110 to be turned on, and outputs a determination signal Dj1 in accordance with the determined result to the voltage control unit 253 on a pixel-by-pixel basis. The pixel 110 to be turned off (a first pixel) is, in other words, the pixel 110 driven in accordance with the data bit Db “0”. On the other hand, the pixel 110 to be turned on (a second pixel) is, in other words, the pixel 110 driven in accordance with the data bit Db “1”.

For each pixel represented by the display data Da, the adjacency determination unit 251 determines, on the basis of the attention pixel Pa illustrated in FIG. 7, whether a period in which the pixel 110 is turned off is present or not. If the period is present, the adjacency determination unit 251 further determines, on the basis of the pixels (hereinafter referred to as “neighboring pixels”) Pn1 to Pn8 adjacent to the attention pixel Pa, whether the pixels 110 are turned on in the period or not. The adjacency determination unit 251 outputs “1” as the determination signal Dj1 if the determination result is “YES”, and outputs “0” as the determination signal Dj1 if the determination result is “NO”. It is to be noted that, hereinbelow, the eight neighboring pixels Pn1 to Pn8 adjacent to the attention pixel Pa, when need not be distinguished from one another, are collectively referred to as “neighboring pixels Pn”.

The gray-scale determination unit 252 determines on the basis of the display data Da whether a difference between the gray level of the attention pixel Pa and the gray level of the neighboring pixel Pn is equal to or greater than a first threshold Th1 and equal to or less than a second threshold Th2, and outputs a determination signal Dj2 in accordance with the determined result to the voltage control unit 253. The gray-scale determination unit 252 outputs “1” as the determination signal Dj2 if the determination result is “YES”, and outputs “0” as the determination signal Dj2 if the determination result is “NO”. The second threshold Th2 represents a gray level greater than the first threshold Th1, and the first threshold Th1 and the second threshold Th2 are each set so as to be associated with the gray level specified for the attention pixel Pa. The gray-scale determination unit 252 stores a LUT representing the association relation between the gray level and the first and second thresholds Th1 and Th2, and makes a determination based on the association relation. It is to be noted that the contents of the first threshold Th1 and the second threshold Th2 will be described later.

The voltage control unit 253 outputs to the data line driving circuit 140 the voltage control signal Vctr for controlling the voltage level of a data signal to be supplied to the pixel electrode 118 of the pixel 110. The voltage control unit 253 ANDS the determination signal Dj1 with the determination signal Dj2, and outputs “1” as the voltage control signal Vctr if both the determination signals are “1”. The voltage control signal Vctr “1” is a signal instructing the data line driving circuit 140 to supply a data signal at the correction level. That is, in cases where the voltage control signal Vctr is “1”, the data line driving circuit 140 supplies a data signal at the correction level to the data line 114 to turn the pixel 110 off.

On the other hand, if at least one of the determination signals Dj1 and Dj2 is “0”, the voltage control unit 253 outputs “0” as the voltage control signal Vctr. The voltage control signal Vctr “0” is a signal instructing the data line driving circuit 140 to supply a data signal at a voltage level in accordance with the data bit Db. That is, in cases where the voltage control signal Vctr is “0”, the data line driving circuit 140 supplies a data signal at the OFF level to the data line 114 if the data bit Db is “0”, and supplies a data signal at the ON level to the data line 114 if the data bit Db is “1”. Subsequently, the actions of the determination unit 25 will be described.

FIGS. 8A and 8B illustrate two pixels 110 adjacent to each other as seen along the arrangement direction thereof. Here, the reason for providing the adjacency determination unit 251 is described. When the data line driving circuit 140 supplies data signals in accordance with the data bits Db, the pixel 110 to be turned on (referred to as the “ON pixel 110A” for convenience of description) and the pixel 110 to be turned off (referred to as the “OFF pixel 110B” for convenience of description) are sometimes adjacent to each other. When the ON pixel 110A and the OFF pixel 110B are adjacent to each other, as illustrated in FIG. 8A, a potential difference caused by a lateral electric field applied between the pixel electrodes 118 of the ON pixel 110A and the OFF pixel 110B is a potential difference between the ON level and the OFF level, and is approximately 5 V here. In contrast, the potential difference of an electric field in a vertical direction (vertical electric field) applied between the pixel electrode 118 and the common electrode 108 is, for example, 7.5 V, depending upon the manner in which the capacitor line 115 is driven. That is, in this case, the intensity of the vertical electric field is not dominant over that of the lateral electric field, and therefore the action of the lateral electric field causes conditions where disclinations are likely to occur.

To discourage the occurrence of disclinations, the intensity of the lateral electric field need only be relatively small with respect to the vertical electric field. Therefore, if the potential of the pixel electrode 118 of the OFF pixel 110B on the low potential side is made higher, the lateral electric field becomes weak compared to the case where the potential of the pixel electrode 118a of the OFF pixel 110B is low. The aforementioned correction level is defined as the voltage level of a data signal for weakening the lateral electric field. As illustrated in FIG. 8B, when a data signal at the correction level is supplied to the OFF pixel 110B, the potential difference between the ON pixel 110A and the OFF pixel 110B is made smaller (here 4 V) compared to the case where a data signal at the OFF level is supplied. As a result, the intensity of the lateral electric field decreases to discourage the occurrence of disclinations to reduce the degradation in display quality of the liquid crystal panel 100. The inventors found that, assuming that the ON level was set to 5 V and the OFF level was set to 0 V, the correction level set to 1 V enabled the occurrence of disclinations to be sufficiently discouraged. However, the potential at the correction level is not limited thereto. The correction level that is even slightly higher in potential than the OFF level is considered to be able to contribute to discouraging the occurrence of disclinations.

From the viewpoint of discouraging the occurrence of disclinations, it is preferable that the data line driving circuit 140 supply data signals at the correction level to all the pixels 110 to be turned off. Unfortunately, on the other hand, raising the potential of the data signal results in a change in displayed contents defined by the display data Da. Accordingly, if a user notices that the change in the displayed contents resulting from the supply of the data signals at the correction level, the change might be perceived as a reduction in quality of the liquid crystal panel 100. In other words, to reduce the reduction in quality of the liquid crystal panel 100, it is preferred not to use data signals at the correction level more than necessary.

Here, the reason for providing the gray-scale determination unit 252 is described. The gray-scale determination unit 252 determines where the degradation in display quality resulting from disclinations is clearly visible. The larger the difference in gray level between the attention pixel Pa and the neighboring pixel Pn in the display data Da, the longer the period in which the potential difference is large between the pixel electrodes 118 of the pixels 110 is, which provides conditions where disclinations are likely to occur. On the other hand, if the difference between a gray level specified for the attention pixel Pa and that specified for the neighboring pixel Pn becomes large to some extent, a user assumes the boundary between the attention pixel Pa and the neighboring pixel Pn as a boundary between images even when disclinations occur. In such a case, disclinations are less likely to be noticed as display defects. That is, in cases where the difference between the gray levels specified for the pixels 110 adjacent to each other is larger than a certain level, the disclinations are not evaluated as display defects even if the occurrence of disclinations is not discouraged.

Therefore, the first threshold Th1 used for determination by the gray-scale determination unit 252 is set on the basis of a gray level difference between the attention pixel Pa and the neighboring pixel Pn from which disclinations arise. The first threshold Th1 is a lower limit value of the gray level difference that allows disclinations to occur. The second threshold Th2 used for determination by the gray-scale determination unit 252 is set on the basis of a gray level difference that allows a user to notice display defects resulting from disclinations. The second threshold Th2 is, for example, the gray level difference with which a user notices a boundary between the attention pixel Pa and the neighboring pixel Pn as a boundary between images. In the case of display in 256 gray scales on the liquid crystal panel 100, for example, the second threshold Th2 may be in the range from 30 to 50 gray scales.

In addition, whether a user assumes the boundary between the attention pixel Pa and the neighboring pixel Pn as the boundary between images is not determined only by the gray level difference. The determination is considered to be also dependent upon the gray level of the attention pixel Pa. For example, in cases where the attention pixel Pa has a gray level close to the lowest value “0” and is considerably dark, and in cases where the attention pixel Pa has a gray level close to the highest value “255” and is considerably bright, it is difficult for a user to visually recognize the boundary even if the gray level difference between the attention pixel Pa and the neighboring pixel Pn is large to some extent. On the other hand, for example, in the case where the attention pixel Pa has a gray level near “128”, which is an intermediate level between the maximum value and the minimum value, even if the gray level difference between the attention pixel Pa and the neighboring pixel Pn is smaller than the gray level, the boundary is considered to be visually recognized by a user. Specifically, compared to a gray level difference of ten between a certain gray level and the gray level “0” or “255”, a gray level difference of ten between the certain gray level and the gray level “128” is more noticeable to a user. Accordingly, the difference between the first threshold Th1 and the second threshold Th2 may increase as the distance of the gray level from an intermediate level increases. The association relation between the gray level of the attention pixel Pa and the first and second thresholds Th1 and Th2 may be experimentally obtained in advance and then be determined in an appropriate manner at the design stage.

The configuration of the display control circuit 20 has been described above. It is to be noted that, in the display control circuit 20, the memory controller 23 and the determination unit 25 are controlled by the timing control circuit 10 so that the data bit Db supplied to the pixel 110 and the voltage control signal Vctr specified for that pixel 110 are in synchronization with each other. Next, specific operation of the data line driving circuit 140 will be described.

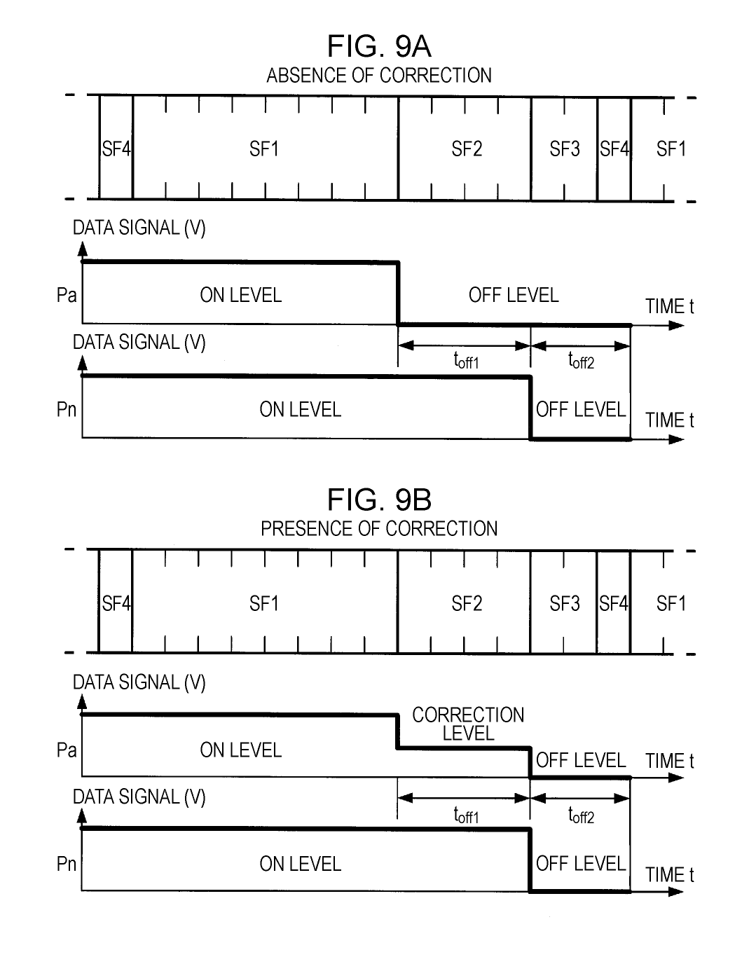

FIGS. 9A and 9B are timing charts illustrating time series variations of data signals supplied from the data line driving circuit 140. FIG. 9A illustrates time series variations of data signals in accordance with the attention pixel Pa and the neighboring pixel Pn in the case of the absence of a data signal at the correction level. FIG. 9B illustrates time series variations of data signals supplied in accordance with the same pixels as in FIG. 9A in the case of the presence of a data signal at the correction level. It is to be noted that, in examples illustrated in FIGS. 9A and 9B, the gray level difference between the attention pixel Pa and the neighboring pixel Pn is assumed to be equal to or greater than the first threshold Th1 and equal to or less than the second threshold Th2, so that the degradation in display quality resulting from disclinations is readily noticeable to a user. In the following description, it is assumed for the sake of brevity that the manner in which the pixel 110 is turned on or off is determined only by a relation between the attention pixel Pa and a certain neighboring pixel Pn. Accordingly, the manner in which the pixel 110 corresponding to the attention pixel Pa is turned on or off can be changed by other neighboring pixels Pn.

As illustrated in FIG. 9A, for the subfield SF4 temporally preceding the first subfield SF1, data signals at the ON level are supplied to the pixels 110 corresponding to the attention pixel Pa and the neighboring pixel Pn. Subsequently, the data line driving circuit 140 turns on the pixel 110 corresponding to the attention pixel Pa for the subfield SF1 and turns that pixel 110 off for the subfield SF2 and later. On the other hand, the data line driving circuit 140 turns on the pixel 110 corresponding to the neighboring pixel Pn for the subfields SF1 and SF2 and turns that pixel 110 off for the subfield SF3 and later.

In this case, when the pixel 110 corresponding to the attention pixel Pa is tuned off for the subfield SF2, the pixel 110 corresponding to the neighboring pixel Pn is turned on for the subfield SF2, and therefore disclinations are likely to occur. Thus, in the case of FIG. 9A, the degradation in display quality resulting from disclinations is readily noticeable to a user in a time period t_{off1}.

In contrast, under the control of the display control circuit 20, as illustrated in FIG. 9B, the pixel 110 corresponding to the attention pixel Pa is turned off by a data signal at the correction level in the time period t_{off1}. Accordingly, in the time period t_{off1}, the lateral electric field between the pixel electrodes 118 of both the pixels 110 is weakened compared to the case of the absence of a data signal at the correction level, and therefore the occurrence of disclinations is discouraged. On the other hand, when both the pixels 110 corresponding to the attention pixel Pa and the neighboring pixel Pn are turned off in a time period t_{off2} including the subfields SF3 and SF4, a data signal at the OFF level is supplied to the pixel 110 corresponding to the attention pixel Pa. Accordingly, in the time period t_{off2}, no change occurs in the displayed contents defined by the display data Da, and therefore the quality of the liquid crystal panel 100 is not reduced compared to the case where the voltage level over the whole period of turn-off driving is the correction level.

In addition, as described above, the data line driving circuit 140 performs turn-off driving using a data signal at the correction level only when the difference in gray level between the attention pixel Pa and the neighboring pixel Pn is equal to or greater than the first threshold Th1 and equal to or less than the second threshold Th2. Thus, in the electro-optical device 1, display control related to reduction of disclinations is performed only when the degradation in display quality is noticeable to a user. In the configuration of subfields in this embodiment, the subfield for turn-on driving temporally precedes the subfield for turn-off driving, and therefore disclinations are likely to occur, for example, upon switching from the bright state to the dark state. Even in this case, turn-off driving using a signal at the correction level makes it possible to discourage the occurrence of disclinations. As described above, according to the first embodiment of the invention, when the pixel 110 to be turned off satisfies conditions under which disclinations are likely to occur, the data line driving circuit 140 turns off the pixel 110 using a data signal at the correction level, which makes it possible to discourage the occurrence of disclinations while reducing the degradation in display quality of the liquid crystal panel 100.

### Second Embodiment

A second embodiment of the invention is now described. In the first embodiment described above, the data line driving circuit 140 turns on or off the pixels 110 using data signals at three types of voltage levels, the ON level, the OFF level and the correction level. In contrast, many of data line driving circuits according to a subfield driving method selectively apply either level of a binary voltage, that is, the ON level or the OFF level. In other words, the pixel 110 is turned on or off with a binary voltage, and therefore the data signal is either at the ON level in accordance with the data bit Db “1” or at the OFF level in accordance with the data bit Db “0”. In the second embodiment, a description is given of the case in which an electro-optical device according to one aspect of the invention is applied to an electro-optical device having the data line driving circuit 140 that applies either level of a binary voltage.

The configuration of an electro-optical device of this embodiment is basically the same as that of the electro-optical device 1 of the first embodiment, and therefore a duplicate description thereof will be omitted. The configuration for reducing disclinations by using the first threshold Th1 and the second threshold Th2 associated with the gray level of the attention pixel Pa is in common with the first embodiment.

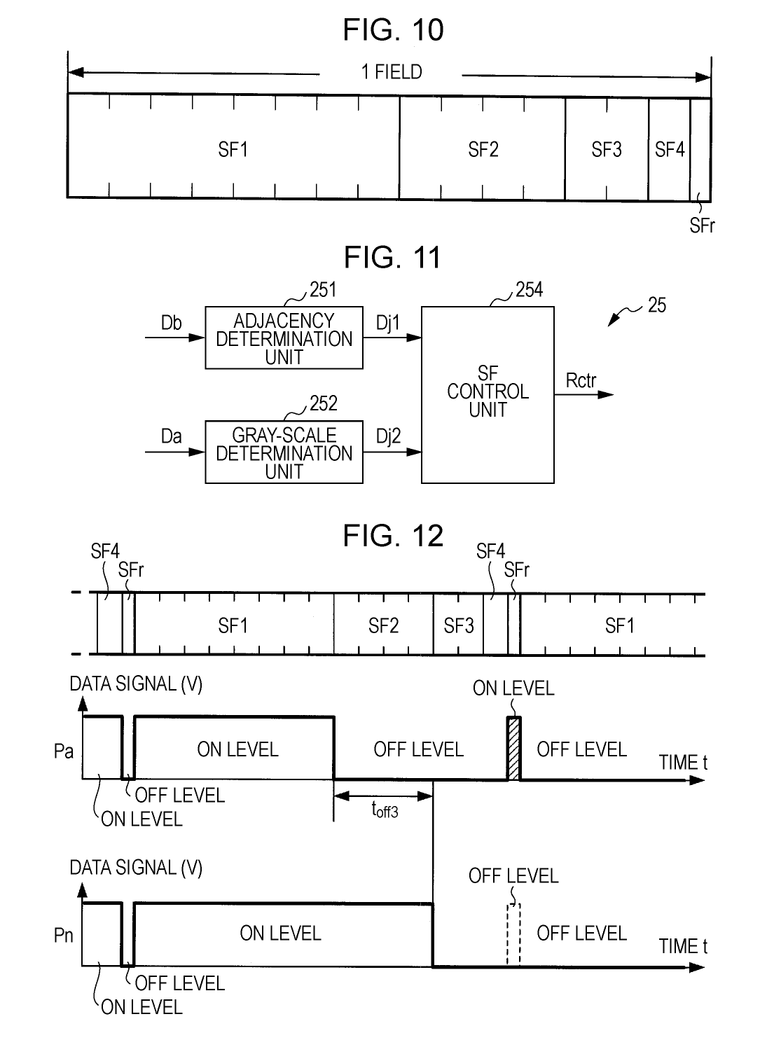

FIG. 10 illustrates the configuration of a field of this embodiment. As illustrated in FIG. 10, also in this embodiment, one frame is equally divided into four, and each period obtained by this division corresponds to one field. Further, one field is divided into five subfields including four subfields (first subfields) SF1 to SF4 that are different in period length from one another, and a subfield (a second subfield) SFr that is shorter in period length than any of the subfields SF1 to SF4. The periods of the subfields SF1 to SF4 decrease in the order SF1>SF2>SF3>SF4, just as in the foregoing first embodiment. The subfield SFr temporally follows the subfields SF1 to SF4. As a result, there is no change in the configuration of the subfields SF1 to SF4 used for gray scale expression. This is considered preferable for gray scale expression.

For the subfields SF1 to SF4, the data line driving circuit 140 turns on or off pixels according to the driving pattern in accordance with a gray level. On the other hand, for the subfield SFr, the data line driving circuit 140 turns on the pixels only in the case of discouraging the occurrence of disclinations, and turns off the pixels in all other cases even with a gray level of the maximum value. Therefore, for the subfields SF1 to SF4, the SF conversion unit 22 determines turn-on driving or turn-off driving in the same manner as in the foregoing first embodiment. However, for the subfield SFr, the SF conversion unit 22 always determines turn-off driving, without determining turn-on driving according to the driving pattern in accordance with a gray level.

FIG. 11 illustrates the configuration of the determination unit 25 of this embodiment. As illustrated in FIG. 11, the determination unit 25 includes the adjacency determination unit 251, the gray-scale determination unit 252 and the SF control unit 254. The configurations of the adjacency determination unit 251 and the gray-scale determination unit 252 are the same as those of the foregoing first embodiment. The SF control unit 254 outputs an SF control signal Rctr specifying for each pixel 110 to the data line driving circuit 140. The SF control unit 254 ANDS the determination signal Dj1 with the determination signal Dj2, and outputs “1” as the SF control signal Rctr if both the determination signals are “1”. The SF control signal Rctr “1” is a signal instructing the data line driving circuit 140 to perform turn-on driving for the subfield SFr. The SF control unit 254 outputs “0” as the SF control signal Rctr if at least one of the determination signals Dj1 and Dj2 is “0”. The SF control signal Rctr “0” is a signal instructing the data line driving circuit 140 to perform turn-off driving for the subfield SFr. The configuration of the determination unit 25 of this embodiment has been described above. It is to be noted that, also in the display control circuit 20 of this embodiment, the operations of the memory controller 23 and the determination unit 25 are controlled by the timing control circuit 10 so that the data bit Db supplied to the pixel 110 and the SF control signal Rctr specifying for each pixel 110 are in synchronization with each other. Next, control performed by the data line driving circuit 140 will be described.

FIG. 12 is a timing chart illustrating time series variations of data signals supplied from the data line driving circuit 140. In an example illustrated in FIG. 12, it is assumed that the gray level difference between the attention pixel Pa and the neighboring pixel Pn is equal to or greater than the first threshold Th1 and equal to or less than the second threshold Th2, so that the degradation in display quality resulting from disclinations is readily noticeable to a user. Also here, it is assumed for ease of description that the manner in which the pixel 110 is turned on or off is determined only by a relation between the attention pixel Pa and a certain neighboring pixel Pn. Accordingly, the manner in which the pixel 110 corresponding to the attention pixel Pa is turned on or off can be changed by other neighboring pixels Pn. Also here, for the subfield SF4 temporally preceding the first subfield SF1 in FIG. 12, data signals at the ON level are supplied to the pixels 110 corresponding to the attention pixel Pa and the neighboring pixel Pn. For the subfield SFr, both the pixels 110 are turned off, and data signals at the OFF level are supplied to the pixels 110. Subsequently, the data line driving circuit 140 turns on the pixel 110 corresponding to the attention pixel Pa for the subfield SF1 and turns that pixel 110 off for the subfield SF2 and later. On the other hand, the data line driving circuit 140 turns on the pixel 110 corresponding to the neighboring pixel Pn for the SF2, and turns that pixel 110 off for the temporally following subfields SF3, SF4 and SF1.

In this case, in a time period t_{off3} in which the pixel 110 corresponding to the attention pixel Pa is turned off for the subfield SF2, the pixel 110 corresponding to the neighboring pixel Pn is turned on for the subfield SF2, which provides conditions where disclinations are likely to occur. In accordance with the subfield SF2, the determination unit 25 outputs the SF control signal Rctr “1”. In receipt of this signal, the data line driving circuit 140 performs turn-on driving for the subfield SFr of the field to which the received SF control signal Rctr “1” is directed. As a result, as illustrated by hatching in FIG. 12, the pixel 110 corresponding to the attention pixel Pa is turned on for the subfield SFr. With this configuration, the time period for turn-on driving in one field increases to weaken the lateral electric field, and therefore, the occurrence of disclinations is more discouraged compared to the case where the subfield SFr is not employed. On the other hand, if one field does not include a time period in which the pixel 110 corresponding to the attention pixel Pa is turned off and the neighboring pixel Pn is turned on, the data line driving circuit 140 performs turn-off driving for the subfield SFr, which results no change in displayed contents defined by the display data Da. Thus, according to the electro-optical device 1 of this embodiment, the quality of the liquid crystal panel 100 is not reduced compared to the case where turn-on driving is performed for all the subfields SFr.

Also, the subfield SFr is shorter than any of the subfields SF1 to SF4. This allows reducing an unintended change of gray scales expressed by the pixels 110, and, as a result, such a change is less noticeable to a user. Also, according to the electro-optical device 1 of this embodiment, the applied voltage to the liquid crystal element 120 can be either at the ON level or at the OFF level, it is possible to provide no device for the structure of the pixel 110 and to employ the data line driving circuit 140 that supplies either level of a binary voltage as a data signal. In addition, the electro-optical device 1 of the second embodiment has the same effects as described in the first embodiment.

### Modifications

The aspects of the invention may be embodied in forms different from the foregoing embodiments. For example, the aspects of the invention may be embodied in the following forms. Further, modifications to be described below each may be combined as appropriate.

### First Modification

In the foregoing embodiments, the display data Da specifies the gray levels of pixels. However, the display data Da may directly specify voltages applied to the liquid crystal elements 120. In cases where the display data Da specifies the voltages applied to the liquid crystal elements, the display control circuit 20 may determine a timing at which the pixel 110 to be turned on and the pixel 110 to be turned off, by the application of the specified voltages, are adjacent to each other, and may perform control for reducing disclinations at the time of turning off the pixel 110 corresponding to the attention pixel Pa.

### Second Modification

In the foregoing embodiments, if both the determination result of the adjacency determination unit 251 and the determination result of the gray-scale determination unit 252 are “YES”, the display control circuit 20 performs control for reducing disclinations. In contrast, with an omission of the configuration corresponding to the gray-scale determination unit 252, the aspects of the invention can be specified. That is, if the determination result of the adjacency determination unit 251 is “YES”, the display control circuit 20 performs control for reducing disclinations, regardless of the gray level of the attention pixel Pa and a difference between that gray level and the gray level of the neighboring pixel Pn. Also, in the foregoing embodiments, the gray-scale determination unit 252 makes an determination based on the display data Da. However, the embodiments may be modified such that a similar determination is made on the basis of the data bit Db.

### Third Modification

In the foregoing second embodiment, the display control circuit 20 divides one field in a manner that the subfields SF1 to SF4 are followed by the subfield SFr. This division manner is only illustrative, and, for example, the subfield SFr may temporally precede the subfields SF1 to SF4. Also, in one field, the subfield SFr may be included between any ones of the subfields SF1 to SF4. A plurality of subfields SFr may be included in one field. Although there is a possibility of affecting gray scale expressions, the inclusion of a plurality of subfields SFr is preferable from the viewpoint of reduction of disclinations. In the foregoing second embodiment, the subfields SF1 to SF4 differ in period length from one another. However, the period lengths may be the same (that is, one field may be equally divided). Also, in the foregoing second embodiment, the time period of the subfield SFr is shorter than any of the subfields SF1 to SF4. However, the configuration may be such that the time period of the subfield SFr is longer than any of the subfields SF1 to SF4. This configuration is preferable for reducing disclinations. Unfortunately, it is preferable from the viewpoint of gray scale expressions that the time period of the subfield SFr be short. In addition, there is a technique of providing intervals between subfields used for gray scale expressions in order to express many gray levels using a few subfields. Even with an electro-optical device that employs this driving method, the aspects of the invention can be specified. In short, the aspects of the invention are applicable to electro-optical devices that express gray scales using subfield driving.

### Fourth Modification

In the foregoing embodiments, the liquid crystal element 120 is not limited to a transmission-type element, and may be a reflection-type element. Further, the liquid crystal element 120 is not limited to an element of a normally black mode, and may be an element of a normally white mode. Also, the liquid crystal 105 may be of a twisted nematic (TN) method, for example, and a normally white mode may be employed in which the liquid crystal element 120 is in a white state in the absence of an applied voltage. Also, for color display, one dot may include three pixels of R (red), G (green) and B (blue). Further, with addition of other colors, one dot may include four or more colors. Also, the number of the scanning lines 112 and the number of the data lines 114 included in the liquid crystal panel 100 are only illustrative. In the foregoing embodiments, the number of subfields used for gray scale expressions for one field is four or five. However, that number may be three or less, or six or more. In addition, the configuration of the foregoing first embodiment may be combined with the configuration of the second embodiment, so that the data line driving circuit 140 performs turn-off driving with a data signal at the correction level and performs turn-on driving for the subfield SFr. In this case, the potential level at the time of turn-on driving for the subfields SF1 to SF4 and the potential level of turn-on driving for the subfield SFr may differ from each other.

### Fifth Modification

In the foregoing embodiments, the display control circuit 20 provides control for reducing disclinations only for the pixel 110 to be turned off that is adjacent to the pixel 110 to be turned on. However, according to the aspects of the invention, control for reducing disclinations may be provided for two or more consecutive pixels 110 to be turned off that are in the opposite direction with respect to the boundary between the pixel 110 to be turned on and the pixel to be turned off. Also, in the foregoing embodiments, the eight neighboring pixels Pn1 to Pn8 are adjacent to the attention pixel Pa. However, in cases where the pixels Pn1, Pn3, Pn5 and Pn7, each of which have no sides facing each other as viewed from the attention pixel Pa, do not cause disclinations, only pixels that each have sides facing each other as viewed from the attention pixel Pa may be assumed as neighboring pixels.

### Sixth Modification

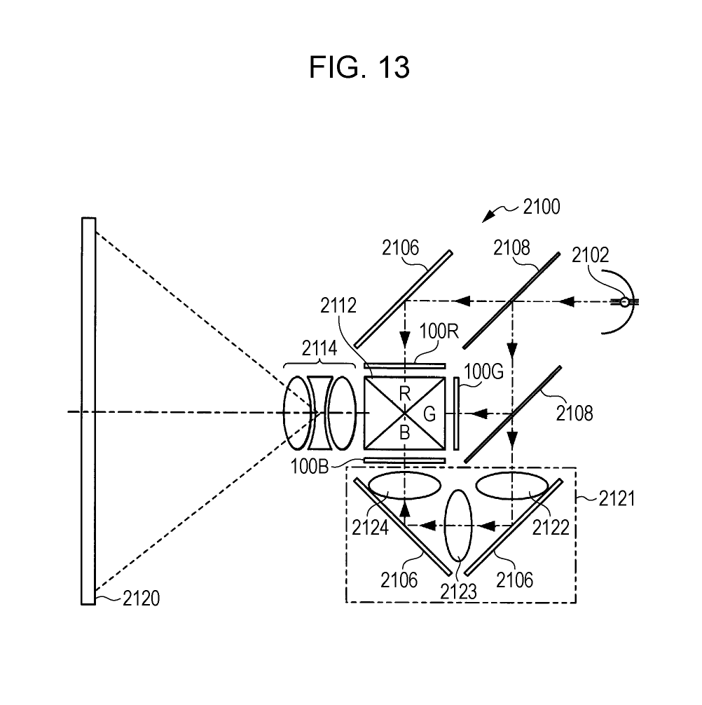

FIG. 13 is a plan view illustrating a configuration of a projector of an embodiment of the electronic apparatus according to the aspects of the invention. Next, a projection type display device (projector) using the liquid crystal panels 100 as light valves are described as one example of the electronic apparatus using the electro-optical device according to the foregoing embodiments. As illustrated in FIG. 13, a lamp unit 2102 made of a white light source such as a halogen lamp is provided inside a projector 2100. Projection light emitted from the lamp unit 2102 is divided into portions of three primary colors, R, G and B, (hereinbelow referred to as “light R”, “light G” and “light B”, respectively), by three mirrors 2106 and two dichroic mirrors 2108 disposed in the inside, and the light R, the light G and the light B are guided to light valves 100R, 100G and 100B corresponding to colors thereof, respectively. It is to be noted that the length of optical path for the light B is longer than those for the light R and the light G, and therefore, in order to prevent the loss in the optical path, the light B is guided through a relay lens system 2121 made up of an entrance lens 2122, a relay lens 2123 and an exit lens 2124.

In the projector 2100, three electro-optical devices each of which includes the liquid crystal panel 100 are provided so as to correspond to colors R, G and B, respectively. The configurations of the light valves 100R, 100G and 100B are similar to the configuration of the foregoing liquid crystal panel 100. Video signals specifying gray levels of primary color components of R, G and B, respectively, are supplied from a higher-level device, and the light valves 100R, 100G and 100B are configured to be driven on the basis of respective video signals. The lights modulated by the light valves 100R, 100G and 100B, respectively, enter a dichroic prism 2112 from three directions. The dichroic prism 2112 refracts the light R and the light B at a 90-degree angle while allowing the light G to travel in a straight line. Accordingly, after images of the primary colors are combined, a color image is projected onto a screen 2120 by a projection lens 2114.

It is to be noted that lights corresponding to colors R, G and B enter the light valves 100R, 100G and 100B, respectively, by means of the dichroic mirrors 2108, and therefore there is no need to provide a color filter. Transmitted images through the light valves 100R and 100B are projected after being reflected from the dichroic prism 2112, and, on the other hand, a transmitted image through the light valve 100G is directly projected. Therefore, the light valves 100R and 100B are configured to have a horizontal scanning direction opposite to that of the light valve 100G to display a horizontally flipped image.

Examples of the electronic apparatus include, in addition to the projector described with reference to FIG. 13, television sets, viewfinder and direct view video tape recorders, car navigation devices, pagers, electronic notebooks, electronic calculators, word processors, workstations, videophones, point-of-sale (POS) terminals, digital still cameras, mobile phones and apparatuses with touch panels. It is to be understood that the foregoing electro-optical device is applicable to these various electronic apparatuses.

The entire disclosure of Japanese Patent Application No. 2010-089273, filed Apr. 8, 2010 is expressly incorporated by reference herein.

What is claimed is:

1. An electro-optical device comprising:
a plurality of pixels, each of the pixels having a liquid crystal element;
a driving circuit that divides one field into a plurality of subfields, and applies predetermined voltages to the liquid crystal elements of the pixels to turn on or off each of the pixels, for each of the subfields according to a driving pattern in accordance with a gray level; and
a determination unit that determines whether a first pixel to be turned off of the pixels is adjacent to a second pixel to be turned on of the pixels,
the driving circuit applying a first voltage to the liquid crystal element corresponding to the first pixel and applying a second voltage higher than the first voltage to the liquid crystal element corresponding to the second pixel, and applying a third voltage higher than the first voltage and lower than the second voltage to the liquid crystal element of the first pixel for which the determination unit has determined that the first pixel is adjacent to the second pixel.

2. The electro-optical device according to claim 1, wherein
the determination unit
stores a first threshold and a second threshold greater than the first threshold, as thresholds set so as to be associated with each gray level, and
determines whether a difference between gray levels specified for the first pixel and the second pixel adjacent to each other is equal to or greater than the first threshold and equal to or less than the second threshold, the first threshold and the second threshold being associated with a gray level specified for the first pixel, and
the driving circuit applies the third voltage to the liquid crystal element of the first pixel for which the determination unit has determined that the first pixel is adjacent to the second pixel and that the difference is equal to or greater than the first threshold and equal to or less than the second threshold.

3. An electro-optical device comprising:
a plurality of pixels, each of the pixels having a liquid crystal element;
a driving circuit that divides one field into subfields including a plurality of first subfields in accordance with a gray level of the each of the pixels and a second subfield different from the first subfields, and turns on or off each of the pixels for each of the subfields; and
a determination unit that determines whether a first pixel to be turned off of the pixels is adjacent to a second pixel to be turned on of the pixels,
the driving circuit turning on or off the each of the pixels according to a driving pattern in accordance with the gray level for each of the first subfields, and turning on the first pixel for which the determination unit has determined that the first pixel is adjacent to the second pixel, for the second subfield.

4. The electro-optical device according to claim 3, wherein the second subfield is a time period shorter than any of the plurality of first subfields.

5. The electro-optical device according to claim 3, wherein the driving circuit applies one level of a binary voltage when turning on each of the pixels, and applies the other level of the binary voltage when turning off each of the pixels, for the first and second subfields.

6. The electro-optical device according to claim 3, wherein
the determination unit
stores a first threshold and a second threshold greater than the first threshold, as thresholds set so as to be associated with each gray level, and
determines whether a difference between gray levels specified for the first pixel and the second pixel adjacent to each other is equal to or greater than the first threshold and equal to or less than the second threshold, the first threshold and the second threshold being associated with a gray level specified for the first pixel, and
the driving circuit performs turning on for the second subfield for the liquid crystal element of the first pixel for which the determination unit has determined that the first pixel is adjacent to the second pixel and that the difference is equal to or greater than the first threshold and equal to or less than the second threshold.

7. The electro-optical device according to claim 3, wherein the driving circuit divides one field such that the second subfield temporally follows the plurality of first subfields.

8. The electro-optical device according to claim 1, wherein, for the subfields for turning on or off according to the driving pattern in accordance with the gray level, the driving circuit causes the subfield for turning on to temporally precede the subfield for turning off.

9. A control method for an electro-optical device including a plurality of pixels, each of the pixels having a liquid crystal element, and a driving circuit that applies a voltage in accordance with displayed contents to liquid crystal elements of the plurality of pixels, the control method comprising:
when controlling the driving circuit to divide one field into a plurality of subfields, and apply predetermined voltages to the liquid crystal elements of the pixels to turn on or off each of the pixels, for each of the subfields according to a driving pattern in accordance with a gray level,
determining whether a first pixel to be turned off of the pixels is adjacent to a second pixel to be turned on of the pixels; and
controlling the driving circuit to apply a first voltage to the liquid crystal element corresponding to the first pixel and apply a second voltage higher than the first voltage to the liquid crystal element corresponding to the second pixel, and to apply a third voltage higher than the first voltage and lower than the second voltage to the liquid crystal element of the first pixel for which the determination unit has determined that the first pixel is adjacent to the second pixel.

10. An electronic apparatus comprising the electro-optical device according to claim 1 in a display section.

11. An electronic apparatus comprising the electro-optical device according to claim 3 in a display section.
